(19) United States
(12) Patent Application Publication
(10) Pub. No.: US 2025/0235842 A1
(43) Pub. Date: Jul. 24, 2025

(54) GAS-PHASE PROCESS FOR MAKING POLYPROPYLENE RANDOM COPOLYMERS

(71) Applicant: W.R. Grace & Co.-CONN, Columbia, MD (US)

(72) Inventors: Dongsheng LI, Liaoning (CN); Ping CAI, Columbia, MD (US); David M. ERDELT, Columbia, MD (US); Andrej HORAK, Bratislava (SK)

(73) Assignee: W.R. Grace & Co.-CONN, Columbia, MD (US)

(21) Appl. No.: 18/699,245

(22) PCT Filed: Oct. 6, 2021
(86) PCT No.: PCT/CN2021/122509

§ 371 Date: Apr. 5, 2024

(51) Int. Cl. B01J 8/18; B01J 8/24; C08F 2/01; C08F 2/34; C08F 210/06

(52) U.S. Cl. CPC B01J 8/1827; B01J 8/24; C08F 2/01; C08F 2/34; C08F 210/06; B01J 2208/00548

(57) ABSTRACT

A gas-phase process for producing a polypropylene random copolymer in a fluidized bed reactor is provided. The process comprises feeding a fluidizing medium into a reactor vessel containing a bed of catalytically active polyolefin particles. In one embodiment, the fluidizing medium comprises propylene gas, C2 and/or C4-C8 α-olefin comonomers, hydrogen, and an inert gas. The momentum flux of the fluidizing medium, defined as is 7.0 N/m² or greater and the condensing level of the reactor cycle gas when entering the reactor is less than 25 wt. %. In the above equation, ρ_{g} is the density of the fluidizing medium and SGV is the superficial gas velocity of the fluidizing medium.

$${( SGV [ \frac{m}{s} ] )}^{2} * {ρ}_{g} [ \frac{kg}{{m}^{3}} ]$$

### BACKGROUND

Polypropylene, a type of polyolefin polymer, generally has a linear structure based on a propylene monomer. One type of polypropylene is a polypropylene random copolymer, which is produced using propylene monomer and comonomer(s) of at least one other α-olefin, such as ethylene and/or 1-butene, which are interspersed randomly within the polypropylene chain. Polypropylene random copolymers exhibit properties that are particularly useful for pipe, packaging, textile, molding, and other applications.

One method for producing polypropylene is typically referred to as gas phase polymerization. During gas phase polymerization, one or more monomers contact a catalyst, forming a bed of polymer particles maintained in a fluidized state by a fluidizing medium, which contains the monomers. A typical gas phase polymerization reactor includes a vessel containing a fluidized bed, a distribution plate (also called distributor plate), and a product discharge system. A catalyst can be fed into the polymerization reactor and contacted with an olefin monomer that forms part of the fluidizing medium.

When producing polypropylene using a gas-phase process, it is important to maintain the operating temperature of the reactor by efficient heat transfer from the polymer particles to the fluidizing gas. Failure to properly remove heat can cause softening and/or melting of the polymer particles which can further cause agglomeration of the particles, sheeting on the reactor walls, and at worst, chunking and blockage of the distribution plate and product discharging system, requiring shut-down of the reactor for cleaning, which typically takes the reactor off-line for days.

Compared to other polypropylene types, random copolymers are relatively more challenging to produce. For example, the presence of the comonomer can increase the heat of the reaction and reduce the melting temperature of the polymer, meaning more heat needs to be removed compared to homopolymer production, and the polymer particles tend to be relatively “stickier.” As such, efficient heat transfer from the polymer particles to the gas is particularly important when producing polypropylene random copolymers. Even following correct operation guidelines to select the proper reactor temperature, level of condensing, and propylene partial pressure, the random copolymer operation could still have problems like polymer agglomeration, unstable reactor temperature, abnormal fluidized bulk density (FBD)/bed level, hot spots in the reactor, etc.

Previous attempts to improve heat transfer in gas-phase polypropylene processes have included the use of mechanical agitators and operating at relatively high superficial gas velocities. However, adding a mechanical agitator, although helping to stir and mix the polymer particle bed in the reactor, has additional negative consequences such as extra surfaces for potential fouling, reliability of the moving parts in reactor, sealing of the axis under high operating pressure, concern of power outage, etc. Further, there is a practical limit of superficial gas velocity as a result of the cycle-gas compressor's capability. As such, there is a need for further improvement.

### SUMMARY

The present disclosure is generally directed to a gas-phase process for producing a polypropylene random copolymer in a fluidized bed reactor. The process comprises feeding a fluidizing medium into a reactor vessel containing a bed of catalytically active polyolefin particles.

In one embodiment, the fluidizing medium comprises propylene gas, C2 and/or C4-C8 α-olefin comonomers, hydrogen, and at least one inert gas. The momentum flux of the fluidizing medium, defined as

$${( S G V [ \frac{m}{s} ] )}^{2} * {ρ}_{g} [ \frac{kg}{{m}^{3}} ] ,$$

is 7.0 N/m² or greater and the condensing level of the reactor cycle gas when entering the reactor is less than 25 wt. %. In the above equation, ρ_{g} is the density of the fluidizing medium and SGV is the superficial gas velocity of the fluidizing medium.

Other features and aspects of the present disclosure are discussed in greater detail below.

### BRIEF DESCRIPTION OF THE DRAWINGS

FIG. 1 is a diagrammatical view of one embodiment of a gas phase polymerization process in accordance with the present disclosure.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

In general, the present disclosure is directed to a gas-phase process for producing a polypropylene random copolymer in a fluidized bed reactor. The present inventors unexpectedly discovered that reactor stability is at least partially a function of the momentum flux of the fluidizing medium within the fluidized bed reactor. Momentum flux as used herein is defined as

$${( S G V [ \frac{m}{s} ] )}^{2} * {ρ}_{g} [ \frac{kg}{{m}^{3}} ] ,$$

where SGV is the superficial gas velocity of the fluidizing medium in the reaction zone of the fluidized bed reactor and ρ_{g} is the density of the fluidizing medium in the reactor. When calculated as shown in the above equation, momentum flux has units of N/m². The superficial gas velocity of the fluidizing medium is defined as the volumetric flow rate of the fluidizing medium divided by the cross-sectional area of the reaction zone of the fluidized bed reactor.

Without intending to be bound by theory, it is believed that increasing the superficial gas velocity of the fluidizing medium and increasing its density results in a larger particle-to-gas heat transfer coefficient, which leads to more efficient removal of the heat of polymerization from the polymer particles to the fluidizing medium. The more efficient heat transfer helps prevent hot spots which could cause polymer softening or melting. Ultimately, this more efficient heat transfer allows for very stable operation of the reactor absent of particle agglomeration, sheeting, and chunking.

While there are methods for manipulating the reactor conditions when such issues emerge to prevent a chunked reactor and full shut down, it is preferable to be able to maintain stable operation without aggressive or delicate manipulation. The present inventors surprisingly found that momentum flux is a strong indicator of reactor stability, as reactors operating with low momentum flux tend to form chunks, reactors with a medium momentum flux can be operated continuously with some special manipulation, and reactors operating at high momentum flux tend to run stably and robustly, without the need of delicate manipulation, while also providing good particle morphology of the granular polymer product.

The present inventors also discovered that, because there is a practical limit to the SGV of the fluidizing medium due to the compressor's capacity in the recycle stream, the momentum flux can be increased by increasing the density of the fluidizing medium through the increase of the reactor total pressure. Increasing the partial pressure of propylene gas can help to increase the total pressure and gas density, but it can also cause some operational problems intended to be prevented, such as over-heating of the polymerization reaction which results in hot spots and polymer particle agglomeration. In fact, the partial pressure of propylene and the partial pressure of the comonomer(s) need to be maintained in a suitable range to provide a good catalyst productivity while not causing the overheating. Therefore, it was found that intentionally increasing the partial pressure of an inert gas, instead of the partial pressure of propylene or comonomer(s), is an effective while safe way to increase the reactor total pressure and gas density, hence to increase momentum flux without causing an “overactive” polymerization. For example, one inert gas that is commonly present as an impurity in the propylene gas supply is propane. Therefore, it is desirable to operate the reactor for random copolymerization with a relatively high propane partial pressure. This can be done by maintaining a relatively high level of propane that accumulates in the reactor via vent-recovery system manipulation, and/or adding additional propane in the feed to the reactor.

There could be a limit of the available propane accumulated in the system because the propylene feed only contains a very small amount of propane and feeding additional propane might involve extra costs such as that for a propane purification system, in addition to the cost of purchasing propane. In addition, when the propane level is very high in the reactor, there could be a number of negative consequences. For example, high levels of propane can cause an excessively high level of cycle-gas to condense when entering the reactor, which increases the pressure of the product discharge system (PDS) and reduces the temperature of the resin in the PDS and product degassing column. This may lead to difficulty achieving a good resin degassing, higher load of the vent recovery system which could cause a lower operation efficiency (i.e., with an increased ratio of consumed monomers and comonomers over the final polymer product), and possible resin particle stickiness. An excessive level of condensing might also trigger the concern of insufficient mixing near the bottom of the reactor because the effective gas velocity is relatively low before the condensates are evaporated. In this regard, typically the level of condensing is about 25% or less, in some embodiments about 20% or less, and in some embodiments about 17% or less. Therefore, additionally or alternatively, the inert gas used to increase the momentum flux can include non-condensable gasses, such as nitrogen. Nitrogen commonly exists as an inert gas in the fluidizing medium. For example, nitrogen comes from the gas streams to purge the nozzles and pressure taps in the gas phase polymerization reactor. During the reactor startup, nitrogen is also heavily used as the fluidization medium before the monomer and comonomer(s) are introduced into the reactor. As such, another convenient and advantageous way of increasing the momentum flux of the fluidizing medium is to increase the partial pressure of nitrogen within the reactor. Preferably, the fluidizing medium has relatively high concentrations of both propane and nitrogen, as long as the concentration of condensable inert gasses remains low enough to prevent excessive cycle gas condening. However, while these inert gasses may be the most readily available, any inert gas can be used to increase the total pressure and thus the density of the fluidizing medium, as long as it will not polymerize monomer/comonomer or poison the reaction.

It has been found that operating the reactor with a momentum flux of 7.0 N/m² or greater provides desirable results of stable and robust copolymerization. Preferably, the momentum flux is 8.3 N/m² or greater, such as 8.5 N/m² or greater, such as 9 N/m² or greater, such as 9.5 N/m² or greater. Typically, the momentum flux is less than 20 N/m², such as less than 18 N/m², such as less than 15 N/m².

The superficial gas velocity (SGV) is limited on the lower end by the minimum fluidization velocity, which is the minimum velocity at which the bed of polymer particles becomes fluidized. Preferably, the SGV is 0.34 m/s or greater, such as 0.36 m/s or greater, such as 0.38 m/s or greater, such as 0.39 m/s or greater, such as 0.4 m/s or greater. The SGV is typically below 0.6 m/s but is limited by the compressor capability or the velocity at which the reactor operation becomes undesired such as with excessive carry over of fine particles out of the reactor.

The gas density of the fluidizing medium, ρ_{g}, is preferably about 55 kg/m³ or greater, such as about 57 kg/m³ or greater, such as about 58 kg/m³ or greater, such as about 59 kg/m³ or greater, such as about 60 kg/m³ or greater. The gas density of the fluidizing medium is typically less than about 80 kg/m³, such as less than about 70 kg/m³.

As described above, the inert gas preferably includes propane. In one embodiment, propane constitutes about 4 mol % of the fluidizing medium or greater, such as about 6 mol % of the fluidizing medium or greater, such as about 8 mol % of the fluidizing medium or greater, such as about 10 mol % of the fluidizing medium or greater, such as about 12 mol % of the fluidizing medium or greater. Typically, propane constitutes less than about 40 mol % of the fluidizing medium, such as about 30 mol % of the fluidizing medium or less, such as about 25 wt. % of the fluidizing medium or less, such as about 20 wt. % of the fluidizing medium or less.

In another embodiment, the inert gas comprises nitrogen. Preferably nitrogen constitutes about 4 mol % of the fluidizing medium or greater, such as about 6 mol % of the fluidizing medium or greater, such as about 7 mol % of the fluidizing medium or greater, such as about 9 mol % of the fluidizing medium or greater, such as about 11 mol % of the fluidizing medium or greater, such as about 13 mol % of the fluidizing medium or greater, such as about 15 mol % of the fluidizing medium or greater, such as about 19 mol % of the fluidizing medium or greater, such as about 25 mol % of the fluidizing medium or greater. Typically, nitrogen constitutes less than about 60 mol % of the fluidizing medium.

In one embodiment, the fluidizing medium contains both propane and nitrogen. Preferably, the sum of the mol % propane and the mol % nitrogen within the fluidizing medium is about 10% or greater, such as about 16% or greater, such as about 25% or greater, such as about 32% or greater. Typically, the sum of the mol % propane and the mol % nitrogen is less than about 70%.

In general, the polymerization described herein is conducted in a fluidized bed gas phase reactor. The polymerization is conducted by reacting propylene and at least one olefin comonomer selected from C2 and C4-8 with a catalyst system, preferably in the presence of hydrogen, to produce a propylene-based polymer. The catalyst system can be a metallocene catalyst system or a Ziegler Natta catalyst system, or even a mixture of Ziegler-Natta and metallocene catalysts. Preferably, the catalyst system is a Ziegler Natta catalyst system.

The propylene polymer can be a propylene copolymer (with single comonomer) or terpolymer (with two comonomers), or even with more comonomers. As used herein, the term propylene copolymer is used broadly to refer to embodiments having a single comonomer or multiple comonomers, therefore including terpolymers. When the polymer is a terpolymer, preferably, one of the comonomers is ethylene. When only one comonomer is used, the random copolymer is preferably a propylene random copolymer with ethylene or 1-butene. The temperature of the polymerization is preferably from about 50 to about 90° C., such as from about 55 to about 75° C., or alternately from about 58 to about 68° C. When hydrogen is present, the ratio of hydrogen to propylene used in the polymerization is preferably about 0.003 to about 0.25, such as from about 0.005 to about 0.18.

The melt flow rate (MFR) of the propylene polymer produced, measured according to ASTM D1238, is typically from about 0.15 to about 400 g/10 min, where measurement of the MFR includes the addition of an antioxidant to provide stable, repeatable measurements. The antioxidant used typically includes 2000 ppm Cyanox-2246, 2000 ppm Irgafos-168 or 1000 ppm ZnO, or equivalents thereof. Preferably, the melt flow rate is from about 0.15 to about 250 g/10 min. More preferably, the melt flow rate is from about 0.2 to about 200 g/10 min. This melt flow rate is measured on the reactor-produced material without subsequent visbreaking.

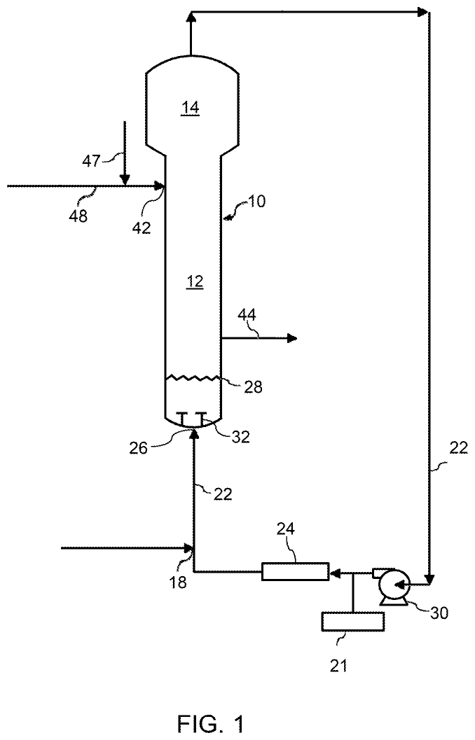

Referring to FIG. 1, for exemplary purposes only, one embodiment of a gas phase polymerization process in a fluidized bed reactor is illustrated. As shown in FIG. 1, the system includes a gas phase reactor 10 that includes a reaction zone 12 and a velocity reduction zone 14. Notably, for the purposes of calculating SGV, the cross-sectional area of the reaction zone should be used. In one exemplary embodiment, the height to diameter ratio of the reaction zone can vary in the range of from about 2:1 to about 7:1.

The reaction zone 12 includes a bed of growing and grown polymer particles, polymerizable monomer(s) and other gaseous components (including inert gases and optionally hydrogen) in the form of fluidizing medium that flows through the reaction zone. As explained above, the SGV of the fluidizing medium (typically in gaseous status in most parts of the reactor) is sufficient to produce a fluidized bed. For example, the superficial gas velocity, can be greater than 1.5 times, such as greater than 2.5 times, such as greater than 4 times of the minimum fluidization velocity.

Make-up fluidizing medium (such as fresh polyolefin monomer(s) to make up those consumed during the polymerization) is generally fed to the process at point 18 and combined with a recycle line 22, or other locations in the cycle loop such as upstream of the compressor 30. The composition of the recycle stream is typically measured by a gas analyzer 21. The SGV in the reactor 10 can be adjusted by adjusting the flow rate of the fluidizing medium passing the compressor 30. The gas analyzer 21, as shown in FIG. 1, can be positioned to test the recycled gas at a point between a compressor 30 and a heat exchanger 24.

The fluidizing medium contained in the recycle stream 22 is fed to the reactor 10 towards the bottom at a point 26 below the bed. The reactor 10 can include a gas distribution plate 28 to aid in fluidizing the bed uniformly and to support the solid particles contained in the fluidized bed. The fluidizing medium passing upwardly through and out of the bed removes the heat of reaction generated by the exothermic polymerization reaction.

As shown in FIG. 1, the fluidizing medium flows through the reactor 10 and into the velocity reduction zone 14. Within the velocity reduction zone 14, most particles drop back to the dense fluidized bed in the reaction zone 12 by gravity, while a small number of fine particles are carried out of the reactor by the fluidizing medium into the cycle loop.

The recycled fluidizing medium is compressed in compressor 30 and passed through a heat exchanger 24. The heat exchanger 24 is for removing the polymerization-reaction heat absorbed by the fluidizing medium when passing the reactor, before the fluidizing medium is returned to the reactor 10. In one aspect, the reactor 10 can include a fluid flow deflector 32 installed at the inlet to the reactor to help better distribute the fluidizing medium in the space below the distributor plate 28, to prevent contained polymer particles from settling out and agglomerating into a solid mass, and to maintain and entrain or to re-entrain any particles and optionally condensed liquid which may settle out or become disentrained. The distributor plate 28 enables the fluidizing medium to enter the fluidized bed in the reaction zone 12 with a uniform velocity and uniform amount of carried fines particles and optionally uniform amount of condensed liquid, in the entire cross-sectional area of the reactor.

Granular polyolefin polymer resin produced by the reaction is discharged from the reactor 10 through the line 44.

In one embodiment, the polymerization catalyst enters the reactor 10 through a nozzle 42 through line 48.

The catalyst stream 48 includes the catalyst particles, optionally a suspending liquid, such as mineral oil or a liquid alkane, and a carrier fluid. The catalyst particles (for example, in the form of slurry by suspending in mineral oil) and the carrier fluid can be injected into the reactor 10 through the nozzle 42. Preferably, on a volume basis, the catalyst stream 48 primarily contains the carrier fluid. For example, the carrier fluid preferably accounts for greater than 50%, such as greater than 60%, such as greater than 70% of the volume of the catalyst stream 48.

The carrier fluid in the catalyst stream 48 can comprise a monomer, a comonomer, an inert hydrocarbon, an inert gas, or mixtures thereof. In one embodiment, for instance, the carrier fluid is a liquid monomer, such as liquid propylene. When liquid propylene is used as the carrier fluid, the flow rate of the catalyst stream 48 is generally greater than about 15 kg/h, such as greater than about 25 kg/h, such as greater than about 55 kg/h. When liquid propylene is used as the carrier fluid, the flow rate of the catalyst stream 48 is generally less than about 250 kg/h, such as less than about 200 kg/h.

Alternatively, the carrier fluid can be an inert gas, such as nitrogen gas. When nitrogen gas is the carrier fluid, the flow rate of the catalyst stream 48 can generally be greater than about 3 kg/h, such as greater than about 5 kg/h, such as greater than about 9 kg/h, and generally less than about 55 kg/h, such as less than about 45 kg/h, such as less than about 30 kg/h.

In addition to the catalyst stream 48, as shown in FIG. 1, the system may further include a support gas stream 47, separate from the catalyst stream 48 until released into the reactor 10. In one embodiment, for instance, the support gas stream 47 is fed into the gas phase reactor 10 through the nozzle 42 in a manner such that the support gas is released at the tip of tube very close to the tip of the catalyst injection tube. Typically, the support gas flows in the support tube which is coaxially arranged with the catalyst injection tube.

When present, the support gas stream generally comprises a monomer, a comonomer, an inert hydrocarbon, an inert gas, or mixtures thereof. In one embodiment, for instance, the support gas can comprise a monomer gas, such as an olefin gas. In one particular embodiment, for instance, the support gas can be vaporized propylene. Preferably, the flow rate of the support gas is greater than about 40 kg/h, such as greater than about 50 kg/h, such as greater than about 60 kg/h. The flow rate of the support gas is preferably less than about 600 kg/h, such as less than about 550 kg/h, such as less than about 500 kg/h.

In an embodiment, the catalyst system is a Ziegler-Natta catalyst composition. Ziegler-Natta catalyst compositions typically include a procatalyst containing a transition metal halide (i.e., titanium, chromium, vanadium), a cocatalyst such as an organoaluminum compound, and optionally an external electron donor.

All different types of Ziegler-Natta catalysts may be used in the process of the present disclosure. A Ziegler-Natta catalyst includes a solid catalyst component. The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula MgaTi(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are in general particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}
where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′) 3 where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

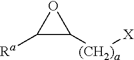

wherein “a” is from 1, 2, 3, 4, or 5, X is F, Cl, Br, I, or methyl, and Ra is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; a-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl) propane; tris(4-glycidyloxyphenyl) methane; poly(oxypropylene) triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl) methane; poly(N,N-glycidylmethylacrylamide); 1,2-epoxy-3-(diphenylcarbamoyl)cyclohexane; 2,3-epoxy-6-(dimethylcarbamoyl) bicycle[2.2.1]heptane; 2-(dimethylcarbamoyl) styrene oxide; 4-(1,2-epoxybutyl)-4′-(dimethylcarbamoyl) biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl) naphthalene.

As an example of the organic phosphorus compound, phosphate acid esters such as trialkyl phosphate acid ester may be used. Such compounds may be represented by the formula:

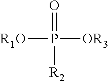

wherein R₁, R₂, and R₃ are each independently selected from the group consisting of methyl, ethyl, and linear or branched (C3-C10) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d50) of between about 8-150 microns, preferably between 10-100 microns, and most preferably between 10-30 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

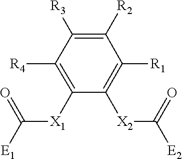

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

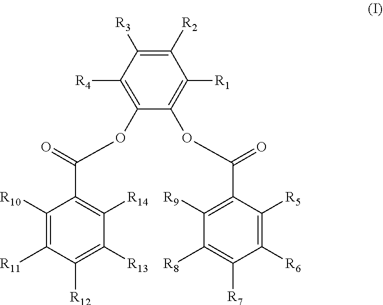

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄ and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄ and R₅-R₁₄ is hydrogen.

In an embodiment, structure (I) includes R₁ and R₃, each of which is a sec-butyl group. Each of R₂, R₄ and R₅-R₁₄ is hydrogen.

In an embodiment, structure (I) includes R₁ and R₄ that are each a methyl group. Each of R₂, R₃, R₅-R₉ and R₁₀-R₁₄ is hydrogen.

In an embodiment, structure (I) includes R₁ that is a methyl group. R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉ and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the solid catalyst component as described above, the Ziegler-Natta catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more selectivity control agents (SCA) and/or one or more activity limiting agents (ALA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises before reaching a very high level. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly-(two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly) (alkylene glycol) mono- or diacetates, (poly) (alkylene glycol) mono- or di-myristates, (poly) (alkylene glycol) mono- or di-laurates, (poly) (alkylene glycol) mono- or di-oleates, glyceryl tri (acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop (for example, the Line 22 in FIG. 1). The selectivity control agent and/or activity limiting agent can combine with the reactor cycle gas within the cycle loop prior to being fed into the reactor.

In addition to Ziegler-Natta catalysts, the process of the present disclosure may also use a metallocene catalyst. Metallocene catalysts can include “half sandwich” and “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom.

The Cp ligands are one or more rings or ring system(s), at least a portion of which includes x-bonded systems, such as cycloalkadienyl ligands and heterocyclic analogues. The ring(s) or ring system(s) typically comprise atoms selected from Groups 13 to 16 atoms, and, in some embodiments, the atoms that make up the Cp ligands are selected from carbon, nitrogen, oxygen, silicon, sulfur, phosphorous, germanium, boron, aluminum, and combinations thereof, where carbon makes up at least 50% of the ring members. For example, the Cp ligand(s) may be selected from substituted and unsubstituted cyclopentadienyl ligands and ligands isolobal to cyclopentadienyl. Non-limiting examples of such ligands include cyclopentadienyl, cyclopentaphenanthrenyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄ Ind”), substituted versions thereof (as discussed and described in more detail below), and heterocyclic versions thereof.

The metal atom “M” of the metallocene compound may be selected from Groups 3 through 12 atoms and lanthanide Group atoms; or may be selected from Groups 3 through 10 atoms; or may be selected from Sc, Ti, Zr, Hf, V, Nb, Ta, Mn, Re, Fe, Ru, Os, Co, Rh, Ir, and Ni; or may be selected from Groups 4, 5, and 6 atoms; or may be Ti, Zr, or Hf atoms; or may be Hf; or may be Zr. The oxidation state of the metal atom “M” can range from 0 to +7; or may be +1, +2, +3, +4 or +5; or may be +2, +3 or +4. The groups bound to the metal atom “M” are such that the compounds described below in the structures and structures are electrically neutral, unless otherwise indicated. The Cp ligand(s) forms at least one chemical bond with the metal atom M to form the “metallocene catalyst component.” The Cp ligands are distinct from the leaving groups bound to metal atom M in that they are not highly susceptible to substitution/abstraction reactions.

In one embodiment, the metallocene catalyst may be represented by the following formula:

(C₅Rₓ)_{y}R′_{z}(C₅Rₘ)MQ_{n-y-1}
wherein:
M is a metal of Groups IIIB to VIII of the Periodic Table of the Elements;
(C₅Rₓ) and (C₅Rₘ) are the same or different cyclopentadienyl or substituted cyclopentadienyl groups bonded to M;
R is the same or different and is hydrogen or a hydrocarbyl radical such as alkyl, alkenyl, aryl, alkylaryl, or arylalkyl radical containing from 1 to 20 carbon atoms or two carbon atoms are joined together to form a C₄-C₆ ring;
R′ is a C₁-C₄ substituted or unsubstituted alkylene radical, a dialkyl or diaryl germanium or silicon, or an alkyl or aryl phosphine or amine radical bridging two (C₅Rₓ) and (C₅Rₘ) rings;
Q is a hydrocarbyl radical such as aryl, alkyl, alkenyl, alkylaryl, or aryl alkyl radical having from 1-20 carbon atoms, hydrocarboxy radical having from 1-20 carbon atoms or halogen and can be the same or different from each other;
z is 0 or 1;
y is 0, 1 or 2;
z is 0 when y is 0;
n is 0, 1, 2, 3, or 4 depending upon the valence state of M;
and n−y is ≥1.

Illustrative but non-limiting examples of the metallocenes represented by the above formula are dialkyl metallocenes such as bis(cyclopentadienyl) titanium dimethyl, bis(cyclopentadienyl) titanium diphenyl, bis(cyclopentadienyl) zirconium dimethyl, bis(cyclopentadienyl) zirconium diphenyl, bis(cyclopentadienyl) hafnium dimethyl and diphenyl, bis(cyclopentadienyl) titanium di-neopentyl, bis(cyclopentadienyl) zirconium di-neopentyl, bis(cyclopentadienyl) titanium dibenzyl, bis(cyclopentadienyl) zirconium dibenzyl, bis(cyclopentadienyl) vanadium dimethyl; the mono alkyl metallocenes such as bis(cyclopentadienyl) titanium methyl chloride, bis(cyclopentadienyl) titanium ethyl chloride, bis(cyclopentadienyl) titanium phenyl chloride, bis(cyclopentadienyl) zirconium methyl chloride, bis(cyclopentadienyl) zirconium ethyl chloride, bis(cyclopentadienyl) zirconium phenyl chloride, bis(cyclopentadienyl) titanium methyl bromide; the trialkyl metallocenes such as cyclopentadienyl titanium trimethyl, cyclopentadienyl zirconium triphenyl, and cyclopentadienyl zirconium trineopentyl, cyclopentadienyl zirconium trimethyl, cyclopentadienyl hafnium triphenyl, cyclopentadienyl hafnium trineopentyl, and cyclopentadienyl hafnium trimethyl; monocyclopentadienyls titanocenes such as, pentamethylcyclopentadienyl titanium trichloride, pentaethylcyclopentadienyl titanium trichloride; bis(pentamethylcyclopentadienyl) titanium diphenyl, the carbene represented by the formula bis(cyclopentadienyl) titanium=CH₂ and derivatives of this reagent; substituted bis(cyclopentadienyl) titanium (IV) compounds such as: bis(indenyl) titanium diphenyl or dichloride, bis(methylcyclopentadienyl) titanium diphenyl or dihalides; dialkyl, trialkyl, tetra-alkyl and penta-alkyl cyclopentadienyl titanium compounds such as bis(1,2-dimethylcyclopentadienyl) titanium diphenyl or dichloride, bis(1,2-diethylcyclopentadienyl) titanium diphenyl or dichloride; silicon, phosphine, amine or carbon bridged cyclopentadiene complexes, such as dimethyl silyldicyclopentadienyl titanium diphenyl or dichloride, methyl phosphine dicyclopentadienyl titanium diphenyl or dichloride, methylenedicyclopentadienyl titanium diphenyl or dichloride and other dihalide complexes, and the like; as well as bridged metallocene compounds such as isopropyl(cyclopentadienyl) (fluorenyl) zirconium dichloride, isopropyl(cyclopentadienyl) (octahydrofluorenyl) zirconium dichloride diphenylmethylene (cyclopentadienyl) (fluorenyl) zirconium dichloride, diisopropylmethylene (cyclopentadienyl) (fluorenyl) zirconium dichloride, diisobutylmethylene (cyclopentadienyl) (fluorenyl) zirconium dichloride, ditertbutylmethylene (cyclopentadienyl) (fluorenyl) zirconium dichloride, cyclohexylidene (cyclopentadienyl) (fluorenyl) zirconium dichloride, diisopropylmethylene (2,5-dimethylcyclopentadienyl) (fluorenyl) zirconium dichloride, isopropyl(cyclopentadienyl) (fluorenyl) hafnium dichloride, diphenylmethylene (cyclopentadienyl) (fluorenyl) hafnium dichloride, diisopropylmethylene (cyclopentadienyl) (fluorenyl) hafnium dichloride, diisobutylmethylene (cyclopentadienyl) (fluorenyl) hafnium dichloride, ditertbutylmethylene (cyclopentadienyl) (fluorenyl) hafnium dichloride, cyclohexylidene (cyclopentadienyl) (fluorenyl) hafnium dichloride, diisopropylmethylene (2,5-dimethylcyclopentadienyl) (fluorenyl) hafnium dichloride, isopropyl(cyclopentadienyl) (fluorenyl) titanium dichloride, diphenylmethylene (cyclopentadienyl) (fluorenyl) titanium dichloride, diisopropylmethylene (cyclopentadienyl) (fluorenyl) titanium dichloride, diisobutylmethylene (cyclopentadienyl) (fluorenyl) titanium dichloride, ditertbutylmethylene (cyclopentadienyl) (fluorenyl) titanium dichloride, cyclohexylidene (cyclopentadienyl) (fluorenyl) titanium dichloride, diisopropylmethylene (2,5 dimethylcyclopentadienyl fluorenyl) titanium dichloride, racemic-ethylene bis(1-indenyl) zirconium (IV) dichloride, racemic-ethylene bis(4,5,6,7-tetrahydro-1-indenyl) zirconium (IV) dichloride, racemic-dimethylsilyl bis(1-indenyl) zirconium (IV) dichloride, racemic-dimethylsilyl bis(4,5,6,7-tetrahydro-1-indenyl) zirconium (IV) dichloride, racemic-1,1,2,2-tetramethylsilanylene bis(1-indenyl) zirconium (IV) dichloride, racemic-1,1,2,2-tetramethylsilanylene bis(4,5,6,7-tetrahydro-1-indenyl) zirconium (IV), dichloride, ethylidene (1-indenyl tetramethylcyclopentadienyl) zirconium (IV) dichloride, racemic-dimethylsilyl bis(2-methyl-4-t-butyl-1-cyclopentadienyl) zirconium (IV) dichloride, racemic-ethylene bis(1-indenYl) hafnium (IV) dichloride, racemic-ethylene bis(4,5,6,7-tetrahydro-1-indenyl) hafnium (IV) dichloride, racemic-dimethylsilyl bis(1-indenyl) hafnium (IV) dichloride, racemic-dimethylsilyl bis(4,5,6,7-tetrahydro-1-indenyl) hafnium (IV) dichloride, racemic-1,1,2,2-tetramethylsilanylene bis(1-indenyl) hafnium (IV) dichloride, racemic-1,1,2,2-tetramethylsilanylene bis(4,5,6,7-tetrahydro-1-indenyl) hafnium (IV), dichloride, ethylidene (1-indenyl-2,3,4,5-tetramethyl-1-cyclopentadienyl) hafnium (IV) dichloride, racemic-ethylene bis(1-indenyl) titanium (IV) dichloride, racemic-ethylene bis(4,5,6,7-tetrahydro-1-indenyl) titanium (IV) dichloride, racemic-dimethylsilyl bis(1-indenyl) titanium (IV) dichloride, racemic-dimethylsilyl bis(4,5,6,7-tetrahydro-1-indenyl) titanium (IV) dichloride, racemic-1,1,2,2-tetramethylsilanylene bis(1-indenyl) titanium (IV) dichloride racemic-1,1,2,2-tetramethylsilanylene bis(4,5,6,7-tetrahydro-1-indenyl) titanium (IV) dichloride, and ethylidene (1-indenyl-2,3,4,5-tetramethyl-1-cyclopentadienyl) titanium IV) dichloride.

An activator may also be used with the metallocene catalyst. The activator, for instance, may be an aluminoxane. Activators that may be used include those that have the following general formula:

M³M⁴ᵥX²_{c}R³_{b-c}
wherein M³ is a metal of Groups IA, IIA and IIIA of the periodic table; M⁴ is a metal of Group IA of the Periodic table; v is a number from 0 to 1; each X² is any halogen; c is a number from 0 to 3; each R³ is a monovalent hydrocarbon radical or hydrogen; b is a number from 1 to 4; and wherein b-c is at least 1.

Compounds having only one Group IA, IIA or IIIA metal which are suitable for the practice of the invention include compounds having the formula:

M³R³ₖ
wherein:
M³ is a Group IA, IIA or IIIA metal, such as lithium, sodium, beryllium, barium, boron, aluminum, zinc, cadmium, and gallium;
k equals 1, 2 or 3 depending upon the valency of M³ which valency in turn normally depends upon the particular group (i.e., IA, IIA or IIIA) to which M³ belongs; and
each R³ may be any monovalent hydrocarbon radical. Examples of suitable R³ groups include any of the R³ groups aforementioned in connection with formula (V).

The present disclosure may be better understood with reference to the following examples.

### EXAMPLES

### Test Methods:

Melt Flow Rate was measured according to ASTM D1238-01 under the conditions of 2.16 kg weight and 230° C.

Superficial Gas Velocity (SGV) was measured by a Venturi device.

Composition of the fluidizing medium was measured by on-line GC, which was frequently calibrated with check gas to ensure the sum of all the components is between 99% and 101%.

Gas Density (ρ_{g}) was calculated instantaneously with the gas composition, temperature and pressure, using the BWR (Benedict-Webb-Rubin) Equation.

Total Pressure was measured by the pressure gauge commonly used in chemical industry.

### Description of Catalysts Used:

Catalyst 1 was made according to US patent application 2010/0173769A1 Example 4.

Catalyst 2 was made according to U.S. patent application No. 20200283553A1.

Catalyst 3 was made according to U.S. Pat. No. 9,593,182, Example 10.

Catalyst 4 was made according to U.S. Pat. No. 5,604,172.

### Description of External Electron Donors Used:

Donor 1 was made according to US patent application 2011/0152067A1, Example J1.

Donor 2 was made according to US patent application 2011/0152067A1, Example H1.

Donor 3 was made according to US patent application 2019/0194438A1, Example IE1.

Donor 4 was made according to US patent application 2011/0152067A1, Example B1.

Donor 5 was made according to US patent application 2011/0152067A1, Example I1.

Various polypropylene random copolymers were produced in commercial scale fluidized bed reactors. The operating conditions for each run are listed below in Table 1. Additionally, the stability of the reactor operation was evaluated for each run. Runs 10 and 11 are comparative examples.

TABLE 1

| | Ethylene | | | | | | | | | | | | |
|---|---|---|---|---|---|---|---|---|---|---|---|---|---|
| | (butene) | MFR | Ziegler- | | | | | ρ_{g} | Total | | Momentum | Production | |
| Run | content | [g/10 | Natta | | SGV | Propane | N₂ | [kg/ | pressure | Condensing | Flux | Rate | |
| # | [mol %] | min] | Catalyst | Donor | [m/s] | [mol %] | [mol %] | m³] | [MPa] | Level (%) | [N/m²] | (Ton/hr) | Operation |
| 1 | (2.0) | 3.0 | 1 | 1 | 0.406 | 12.4 | 19.8 | 61.4 | 3.20 | 9.6 | 10.1 | 18.3 | Very stable, good |
| | (4.0) | 3.0 | | | | | | | | 9.0 | | 18.8 | particle morphology |
| | (4.2) | 45 | | | | | | | | 7.7 | | 18.3 | |
| 2 | 4.0 | 12 | 1 | 2 | 0.41 | 4.5 | 26.0 | 58 | 3.0-3.1 | 10.0-12.0 | 9.7 | 53 | Very stable, good |
| | | | | | | | | | | | | | particle morphology |
| 3 | 3.8 | 82.3 | 1 | 2 | 0.4 | 6.5 | 7.4 | 60.7 | 3.16 | 11.9 | 9.7 | 30 | Very stable, good |
| | | | | | | | | | | | | | particle morphology |
| 4 | 3.7 | 48 | 1 | 2 | 0.4 | 7 | 6.5 | 59.3 | 3.08 | 12.4 | 9.5 | 30 | Very stable, good |
| | | | | | | | | | | | | | particle morphology |
| 5 | 3.7 | 22 | 2 | 3 | 0.4 | 8.6 | 10.2 | 55.4 | 2.95 | 6.0 | 8.9 | 18.2 | Very stable, good |
| | 3.7 | 55 | | | | | | | | 6.0 | | 18.2 | particle morphology |
| 6 | 3.6 | 25 | 1 | 2 | 0.389 | 11.3 | 11.3 | 56.6 | 2.97 | 7.3 | 8.6 | 31.2 | Very stable, good |
| | | | | | | | | | | | | | particle morphology |
| 7 | 3.5 | 12 | 3 | 4 | 0.38 | 7.7 | 11.2 | 57.4 | 3.03 | 7.7 | 8.3 | 36.4 | Very stable, good |
| | 3.5 | 16 | | | | | | | | 7.7 | | 38.0 | particle morphology |
| 8 | 3.4 | 25 | 2 | 3 | 0.374 | 6.4 | 10.4 | 57.2 | 3.05 | 7.0 | 8.0 | 17.2 | Good, but with |
| | 3.7 | 62 | | | | | | | | 6.8 | | 18.0 | some manipulation |
| | | | | | | | | | | | | | to turn down the |
| | | | | | | | | | | | | | increasing trend of |
| | | | | | | | | | | | | | lower FBD (twice) |
| 9 | 3.7 | 7.0 | 1 | 2 | 0.35 | 6.8 | 12.1 | 57.5 | 3.11 | 6.2 | 7.0 | 18.1 | Good with some |
| | 3.7 | 25 | | | | | | | | 6.7 | | | manipulation, and |
| | | | | | | | | | | | | | the need of one |
| | | | | | | | | | | | | | reactor mini kill |
| | | | | | | | | | | | | | to help make the |
| | | | | | | | | | | | | | operation stable |
| 10 | 3.6 | 25 | 4 | 5 | 0.354 | 2.4 | 12.1 | 52.8 | 2.99 | 7.5-7.9 | 6.6 | 39.1 | OK for 1 day. Then |
| | | | | | | | | | | | | | reactor wall |
| | | | | | | | | | | | | | temperature rose up |
| | | | | | | | | | | | | | and there was a |
| | | | | | | | | | | | | | severe incr [symbol] [symbol] f |
| | | | | | | | | | | | | | upper FBD and |
| | | | | | | | | | | | | | decrease of lower |
| | | | | | | | | | | | | | FB [symbol] [symbol] en the reactor |
| | | | | | | | | | | | | | was chunked. |
| 11 | 3.5 | 12 | 3 | 4 | 0.351 | 2.7 | 11.1 | 49.9 | 2.96 | 3.4 | 6.1 | 35 | Chunked reactor |
| | | | | | | | | | | | | | before getting st [symbol] |
| | | | | | | | | | | | | | operation |

* FBD = Fluidized Bulk Density [symbol]
indicates data missing or illegible when filed

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A process for producing a polypropylene random copolymer in a fluidized bed reactor comprising:
feeding a fluidizing medium into a reactor vessel containing a bed of catalytically active polyolefin particles, the fluidizing medium comprising propylene gas, C2 and/or C4-C8 α-olefin comonomer(s), hydrogen, and at least one inert gas, wherein the momentum flux of the fluidizing medium, defined as
$${( S G V [ \frac{m}{s} ] )}^{2} * {ρ}_{g} [ \frac{kg}{{m}^{3}} ] ,$$
is 7.0 N/m² or greater, wherein ρ_{g} is the density of the fluidizing medium and SGV is the superficial gas velocity of the fluidizing medium, and wherein the condensing level of the reactor cycle gas when entering the reactor is about 25 wt. % or less.

2. The process according to claim 1, wherein the momentum flux of the fluidizing medium is 8.3 N/m² or greater.

3. The process according to claim 1, wherein the inert gas comprises nitrogen.

4. The process according to claim 1, wherein the inert gas comprises propane.

5. The process according to claim 1, further comprising feeding a catalyst into the reactor vessel.

6. The process according to claim 1, wherein the SGV is about 0.34 m/s or greater.

7. The process according to claim 1, wherein the comonomers comprise ethylene.

8. The process according to claim 1, wherein the comonomers comprise 1-butene.

9. The process according to claim 1, wherein the polypropylene random copolymer comprises propylene monomeric units in an amount from about 80 to about 99.5 mol %.

10. The process according to claim 1, wherein the fluidizing medium contains propane in an amount of about 6 mol % or greater.

11. The process according to claim 1, wherein the fluidizing medium contains nitrogen in an amount of about 11 mol % or greater.

12. The process according to claim 1, wherein the fluidizing medium contains nitrogen and propane in amounts such that the sum of the mol % of nitrogen and the mol % of propane is greater than about 10%.

13. The process according to claim 1, wherein the density of the fluidizing medium is greater than about 55 kg/m³.

14. The process according to claim 1, wherein the condensing level of the reactor cycle gas when entering the reactor is about 20 wt. % or less.

15. The process according to claim 1, wherein ρ_{g} is about 70 kg/m³ or less.

16. The process according to claim 1, wherein propane constitutes less than 25 mol % of the fluidizing medium.
